(19) United States
(12) Patent Application Publication
(10) Pub. No.: US 2013/0111519 A1
(43) Pub. Date: May 2, 2013

(54) Exchange Value Engine

(71) Applicants: James C. Rice, Middleton, WI (US); Alistair B. Wyse, Dronfield (GB)

(72) Inventors: James C. Rice, Middleton, WI (US); Alistair B. Wyse, Dronfield (GB)

(21) Appl. No.: 13/659,978

(22) Filed: Oct. 25, 2012

Related U.S. Application Data
(60) Provisional application No. 61/552,010, filed on Oct. 27, 2011.
(60) Provisional application No. 61/580,037, filed on Dec. 23, 2011.

(51) Int. Cl. H04N 21/458

(52) U.S. Cl. 725/34

(57) ABSTRACT

A method and system are provided for controlling the delivery of advertising and ad-supported multimedia content. The method includes the steps of collecting personal information related to one or more subscribers to a media delivery service, and assigning exchange values to advertisements to be viewed. The exchange values assigned to each advertisement are uniquely determined for each of the one or more subscribers based on the degree of match between a subscriber profile and an advertiser's target audience profile, which includes a maximum price associated with a perfect match. The respective exchange values are based on calculations that take into account the personal information collected from the respective one or more subscribers.

### CROSS-REFERENCE TO RELATED PATENT APPLICATIONS

This patent application claims the benefit of U.S. Provisional Patent Applications No. 61/552,010, filed Oct. 27, 2011 and 61/580,037, filed Dec. 23, 2011, the entire teachings and disclosure of which are incorporated herein by reference thereto.

### FIELD OF THE INVENTION

The present invention relates generally to systems and methods for providing advertising to consumers.

### BACKGROUND OF THE INVENTION

Approximately 65% of video advertisements associated with viewing ad-supported content are ignored by consumers. The estimated total amount spent on advertising in the U.S. for 2011 is about $130 billion. Of this, about $66 billion is for TV advertising, which means about $43 billion is wasted. Waste is attributed to consumers employing Digital Video Recorders (DVRs) and companion media (smartphones, computers, tablets, magazines, etc.) to ignore video advertisements associated with advertising breaks in ad-supported content. DVRs are used for skipping ads and companion media are used to turn attention away from the advertisement to catch-up on emails, web-surf and text friends.

Consumers are also growing weary of the intrusiveness and irrelevancy of advertisements inserted into ad-breaks of ad-supported content. They are greatly concerned over the security and privacy of their Digital Ecosystem (with anything digital and/or connected to the Internet). Consumers are also concerned about their subscription video service collecting viewing video content viewing behavior as well. Government regulators share these concerns.

The current environment in which consumers experience advertising is sometimes chaotic and untrustworthy. As a result, advertisers are operating in increasingly adverse conditions. The irony is that much of the adversity is directly due to actions of these advertisers.

New advertising business models and technologies that create a much better relationship between consumers and advertisers are required. Systems and methods that deliver transparency between consumers and advertisers, assure privacy, and give control of the viewing experience to the consumer are desperately needed in the marketplace.

By providing the consumer control over their experience when viewing advertisements and ad-supported content, all stakeholders in the advertising and ad-supported content value chain will benefit. Regulatory issues around privacy will be mitigated by the transparency afforded by the systems and methods described herein and the control it provides the consumer in all aspects of their advertising content consumption experience and the use of consumer profile information by those that employ embodiments of the present invention.

These and other advantages of the invention, as well as additional inventive features, will be apparent from the description of the invention provided herein.

### BRIEF SUMMARY OF THE INVENTION

Various embodiments of the present invention relate to systems and methods for providing consumers and advertisers a safe and trusted place to meet within their Digital Ecosystems to engage in an authentic exchange of value when an advertisement is viewed. More particularly, various embodiments of the present invention relate to systems and methods for providing user controlled video, audio, animated, graphical, pictorial, printed and other advertising as it pertains to ad-supported audio, video, pictorial, printed and other content and other media through mobile, wire-line, satellite, wireless, and web-based means and devices. Various embodiments also match and rate Subscriber Profiles with Advertiser Target Audience Profiles and then apply such ratings to the cost that Advertisers pay for the viewing of advertisements and the compensation the Subscriber receives for viewing an advertisement.

Various embodiments of the present invention provide a very tight link between a Subscriber's Profile Information and the target audience an Advertiser wishes to address whilst protecting the Subscriber's Personally Identifiable Information. Various embodiments of the invention will enable the precise assignment of cost to advertisers of a verified view of an advertisement by a consumer and such assignment of cost is proportional to the relevancy (degree of match) between the consumer and the Target Audience Profile (TAP) configured by the advertiser for the advertisement.

Various embodiments of the invention will function online via broadband communication through a browser, Application (App) or subscription-based service offered by cable television, telephone, satellite, wireless, mobile or other access service providers. Various embodiments will also function with subscription services to access content (such as cable TV, satellite, telephone, wireless access), online video, print media and print media paywalls to enable consumers to pay for access to content and/or subscription services to such access via credits earned by watching and engaging with advertisements with respect to consumer experiences employing embodiments. Various embodiments of the invention should actually create a demand for appealing and well-crafted advertising content. Various embodiments of the invention enable Advertisers to gain control over the cost of the placement of advertisements by linking Cost per Verified View (CPV²) to the specific relevancy a consumer has to the advertiser. Content owners and aggregators are likely to experience higher viewership, more revenues, better margins, and reduced piracy and copyright infringement as a result of higher consumer satisfaction.

For a consumer to view ad-supported content without advertising breaks or intrusions, they must become a Subscriber to the Service first and then, when presented with the option, pay for the license to view the content using credits earned as a Subscriber when viewing advertisements. According to at least one embodiment, the system provides a Subscriber with three methods of payment: 1) Exchange Notes (credits); 2) Cash (credit card); or 3) Split Tender.

For at least one embodiment of the invention, a system, method, and platform is provided that enables a Subscriber to create Exchange Notes by interacting dynamically with an Advertiser's advertisement. Dynamic interaction takes the form of the Subscriber selecting, viewing, and interacting with an Advertisement through an Advertising Viewing Event (AVE). Interaction may take the form of, but is not limited to, post view surveys, telescoping, click-to-buy, click-to-chat, link-out, email, call to conversion, request for information, share, rating of ads, digital coupons, etc. The monetary value of the interaction between a Subscriber and an advertisement, i.e., the Exchange Value, is assigned by the Exchange Value Engine (EVE) of the Invention and reflects the degree of match between a Subscriber's Profile Information and an Advertiser's Target Audience Profile (TAP) and the Price or Bid by the Advertiser for a perfect match that is tagged (TAP-Tag) to an advertisement. After an AVE has been verified, Exchange Notes are issued to the Subscriber with a monetary value expressed in US Currency equal to the Exchange Value assigned by the EVE and adjusted through a reconciliation process. The Subscriber can use their Exchange Notes for the purchase of a license to view content without advertising breaks, the purchase of content outright or with advertising breaks, move through a paywall, or purchase goods and services at participating businesses. Exchange Notes may also be exchanged for coupons to be used when buying merchandise, to add airline miles to their mileage accounts, or other forms of Consumer rewards, loyalty program or awards by merchants or advertisers. These can be associated with advertisements.

Exchange Notes are used by a Service employing at least one embodiment of the system to invoice Advertisers for a completed and verified AVE. Advertisers are provided verifiable proof that an advertisement was engaged and/or interacted with. Advertisers can control the Exchange Value by the price they are willing to pay for a 100% match between a Subscriber's Profile Information and their Target Audience Profile. During that process, the Advertiser 106 tags each advertisement with a detailed definition of their target audience that may include but not be limited to demographic information, personas¹, gender, age, income range, etc., and then assign a monetary value to an ideal target audience viewing the advertisement (Target Audience Profile 124 or TAP-Tag). All Profile Information is controlled by the Subscriber 102 on an Opt-In basis. The value of an AVE to Advertisers 106 is directly related to the quality and quantity of a Subscriber's Profile Information and the degree it matches to the Advertiser's Target Audience Profile Tag (TAP-Tag) to the advertisement. This match by the EVE 100 directly affects Exchange Value 120, the assignment of Exchange Notes 126, and the cost of the AVE to the Advertiser 106. ¹ Personas are fictional characters created to represent the different user types within a targeted demographic, attitude and/or behavior set that might use a site, brand or product in a similar way. (Wikipedia)

The Exchange Value assigned by the EVE is a direct result of calculations that incorporate a multitude of dynamic data inputs by the Subscriber and Advertiser to include but not be limited to Subscriber Profile Information and permissions and Advertiser parameter definitions, weights and rates, as well as other information that make up the Target Audience Profile Tags (or TAP-Tags).

At least one embodiment of the invention enables the Subscriber to control permissions granted to the Service provider to access a multitude of Subscriber profile data that reside in 3^{rd}-party sources. Data imported into a Subscriber's profile through permissions are Permissible Data Elements of the Subscriber's Profile. Permissible Data Elements that make up the Subscriber's Profile characterize the Subscriber to be matched to an Advertiser's Target Audience Profiles while not divulging the Subscriber's Profile Information and Personally Identifiable Information to the Advertiser.

At least one embodiment of the invention enables the Advertiser to set parameters within the EVE that weigh and assign value to individual data elements within a set of multiple Permissible Data Elements that are part of a Subscriber's Profile Information prospectively engaging in an AVE. Setting these parameters is part of the Advertisers TAP-Tag process. For example, the Subscriber grants permission for the Service provider to use zip code demographic information for matching a Subscriber's Profile Information to an Advertiser's Target Audience Profile Tag. This is an example where the value of a Subscriber's view of an advertisement (through an AVE) to an Advertiser for snowshoes would differ whether they live in a Maine zip code or a Florida zip code.

An additional example would be a member of a ballerina club would be less relevant to the advertiser of a muscle car when compared to a member of the NASCAR Club of America. Other Permissible Data Elements that enable a better more valuable match of a Subscriber's Profile Information to the Advertiser's Target Audience Profile Tag would include but not limited to education (degrees), educational institutions attended, community activity, church affiliations, hobbies, volunteer work and associations, and brand preferences. An additional example could be where an Advertiser assigns a greater value to a Subscriber for an AVE about a one brand of car when that subscriber has a preference for that brand as opposed to another brand of car. Depending on the advertisement, it may be the other way around. The TAP-Tag process of at least one of the embodiments provides the Advertiser a platform to create deep and extensive multidimensional profiles of their target audiences and the assignment of a value for a view by a Subscriber with a perfect match. The Exchange Value Engine (EVE) rates the match between Subscriber and Advertisement and then assigns an Exchange Value that, after the completion of an Advertising Viewing Event (AVE), is then converted to an Exchange Note.

The output from the EVE is a specific Exchange Value for a specific Advertising Viewing Event (AVE). Exchange Values associated with an AVE will vary depending on the Advertiser's assignment of a Maximum Exchange Value (based on the Advertiser's TAP-Tag), the Permissible Data Elements associated with a specific Subscriber's Profile Information, Advertiser Set Parameters (ASP) within the TAP-Tagging process, Subscriber Permissions, and degree of interactivity or engagement of a Subscriber. As Subscriber Profile Information changes, the Exchange Value will also change for a specific advertisement (AVE).

According to at least one embodiment of the invention, Advertisers can withdraw an advertisement when the sum of the monetary value of the Exchange Notes for specific advertisements reaches an assigned monetary value or cap.

In a particular embodiment, the system enables Advertisers to dynamically and in real-time or near real-time, modify parameters through Advertiser-created algorithms or other means such that the Maximum Exchange Value could change over time and as the number of AVEs grows.

In an embodiment of the invention, the system enables Subscribers to view advertising and content on a computer, TV, tablet, smart phone, and other stationary and mobile devices. In a further embodiment, the system provides Subscribers a system, method, and platform to manage the Subscriber's Profile Information and their Personally Identifiable Information and the permissions granted to Service Providers to import 3^{rd} party information within the Subscriber's Digital Ecosystem, across mobile, satellite, wireless and other platforms, and through subscription TV, print, and other content services.

In one aspect, embodiments of the invention provide a method for providing control over the delivery, consumption, and exchange of value with an advertiser upon the selection and viewing of an advertisement by one or more subscribers to a media service. The method includes collecting personal information related to the one or more subscribers, and assigning exchange values to an advertisement. Each of the exchange values is uniquely determined for each of the one or more subscribers. The respective exchange values are based on calculations that take into account the personal information collected from the respective one or more subscribers. Collecting personal information typically involves collecting only that personal information permitted by each of the one or more subscribers.

More particularly, the method may include collecting one of demographic information, behavioral information, brand preferences, hobbies, interests, group affiliations, and credit information related to the one or more subscribers. In particular embodiments, this includes collecting personal information from third-party databases, or collecting personal information from data relating to the behavioral patterns of the one or more subscribes based on the use of internet connection devices and applications.

In certain embodiments, the method includes verifying the completion of each advertising viewing event, in which one of the one or more subscribers views one of the advertisements. In further embodiments, the method includes dynamically adjusting the exchange values associated with the advertisement based on a total number of advertising viewing events for the advertisement. In alternate embodiments, the method includes dynamically adjusting the exchange values associated with the advertisement based on the advertiser set parameters within the target audience profile which indicate at which time of day and which days of the week the one or more subscribers will be most likely to be interested in the advertisement.

Other embodiments of the method include converting one of the exchange values for the advertisement into an exchange note upon verifying that one of the one or more subscribers, to whom the exchange value was assigned, has viewed the advertisement, constituting a completed advertising viewing event, wherein the exchange note can be used by the one of the one or more subscribers as currency for a purchase of goods and services. In particular embodiments, the method includes delivering, to an advertiser, anonymized subscriber profile information that was used by the exchange value engine in the calculation of the exchange value.

In certain embodiments, the method includes a service provider maintaining the subscriber's exchange notes, and providing media content or other products or services when the subscriber's exchange notes, or some portion thereof, are redeemed by the subscriber. In a further embodiment, the method includes an advertiser providing the advertisement and assigning to the advertisement a maximum exchange value.

Embodiments of the method include creating a target audience profile for each advertisement, wherein the advertiser creates the target audience profile to identify a subscriber the advertiser would like to reach and most likely to be interested in the advertisement, and wherein the target audience profile is used to assign the maximum exchange value. The method may also include rating a degree of match between a particular subscriber and the target audience profile. In particular embodiments, the method includes tagging each advertisement with a target audience profile, wherein the target audience profile identifies a target audience of the advertisement that is most likely to be interested in the advertisement.

In a further embodiment, the method includes creating an advertising viewing event label representing the advertisement and its exchange value, and ranking and ordering placement of the advertising viewing event label on a webpage where the one or more subscribers select advertisements to view. Particular embodiments include caching advertisements to a set-top box, home media gateway, or other device for the purpose of inserting relevant advertisements into live streaming media at advertising breaks, wherein the assigned exchange values determine which advertisements are cached to the set-top boxes, home media gateways, or other devices of the one or more subscribers.

In another aspect, embodiments of the invention provide an Exchange Value Engine having a computer server programmed to provide, via a network, targeted advertisements to one or more subscribers to a media service, wherein, to provide such targeted advertisements. The server is further programmed to receive target audience profiles from advertisers, and to collect personal information over the network, the personal information related to the one or more subscribers. The herein the computer server is programmed to calculate exchange values for each of the targeted advertisements, based on the target audience profiles, which identify the subscriber targeted and most likely to be interested in the advertisement. Calculation of exchange values are based on the personal information related to the one or more subscribers. The exchange values associated with a particular targeted advertisement are unique for each of the one or more subscribers.

In certain embodiments, the server is further programmed to rate a degree of match between the personal information for each of the one or more subscribers and the target audience profile for each of the targeted advertisements. Further, the server may be programmed to collect only the personal information permitted by each of the one or more subscribers. The degree of match can increase or decrease with each piece of personal information that a subscriber permits to be collected. In a further embodiment, the server is programmed to track completion of an advertising viewing event, in which it is verified that a particular targeted advertisement has been viewed by any of the one or more subscribers. In some embodiments, the server includes facial recognition hardware and software configured to determine an identity of one of the one or more subscribers who has viewed a particular targeted advertisement, and/or voice recognition hardware and software configured to determine an identity of one of the one or more subscribers who has viewed a particular advertisement.

In a particular embodiment of the invention, the server is programmed deliver anonymized subscriber profile information employed by the exchange value engine for the calculation of the exchange value for an advertising viewing event to be provided advertisers along with invoicing for verified views of an advertisement.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a schematic block diagram illustrating a system level relationship between the Exchange Value Engine and the various systems which interact with the Exchange Value Engine, according to an embodiment of the invention;

FIG. 2 is a schematic block diagram which illustrates how Exchange Values are created and assigned to Advertising Viewing Events, in accordance with an embodiment of the invention;

FIG. 3 is a schematic block diagram which illustrates how Exchange Values are converted into Exchange Notes, according to an embodiment of the invention;

FIG. 4 is a schematic block diagram which illustrates how the Exchange Value Engine enables insertion of relevant advertisements into live video content, in accordance with an embodiment of the invention;

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

The following is a detailed description of various embodiments of the present invention. The detailed description is not intended to be limiting on the embodiments of the invention or to limit the scope of the claims. One who is skilled in the identified Field will appreciate the full scope of the overall invention including various embodiments.

Various embodiments of the invention, describing systems and methods for the delivery of multimedia advertising content to consumers, are provided herein. While describing the systems and methods, the various terms used to describe these embodiments are meant to have the following definitions associated with their use.

Access Network. The Access Network is the physical network used to deliver video, print media, audio and other digital content to the consumer's premise. The Access Network can be provided by a Cable Television provider, a Telephone company using wireless, wireline, satellite, or any other distribution network that links the consumer to the transmission of content. Components used to enter the Access Network include home media gateways, game consoles, set-top boxes (such as those used for cable TV service), computers, tablets, smartphones, routers, switches, deep packet inspection devices, etc.

Ad-Supported Content. All content that is ad-supported and is in the form of video, print, audio, and other forms of media employed for the purpose of communicating. Video content such as TV shows that contain advertising breaks that are typically filled with either fifteen- or thirty-second video advertisements. Content is either real-time (live) or static (pre-recorded and produced). Other audio and video content is contemplated beyond traditional content.

Advertiser. An Advertiser is a company or agency that creates and distributes an advertisement for a product, service, or communicating a message, brand or other purpose. Advertisers include companies that produce and deliver products and services as well as agencies, agency trading desks, creative optimization firms, retargeting companies, companies operating ad servers, ad verification services, media planning organizations, DSPs, media buying desks, ad networks, encoding/transcoding services, and advertising exchanges.

Advertisement Viewing Event (AVE). An Advertisement Viewing Event (AVE) is an event where a Subscriber views and/or interacts with a specific advertisement.

Maximum Exchange Value. The Maximum Exchange Value is a value set by an Advertiser for an AVE. The Maximum Exchange Value is modified in the EVE to reflect the degree of match between a Subscriber's Profile and the Advertisers' Target Audience Profile. Weights are also assigned to Permissible Data Elements of the Subscriber's Profile by the Advertiser that directly impact the actual Exchange Value assigned to an AVE. The Maximum Exchange Value reflects an Advertiser's starting point for an expected Cost per Verified View (CPV²) for an executed AVE with a Subscriber that is a perfect match to their Target Audience Profile.

Behavior Capture. Behavior Capture is a technology that measures a Subscriber's web browsing activities and adds these activities to the Subscriber's Profile as a Permissible Data Element.

Cloud Services. A Cloud Service is an Internet based hosting platform in which Subscribers and Service Providers, that use the platform, share the underlying hardware and software. By using shared platform, the provider of a Service is able to offer more flexible and quickly scalable services, service features, and hosting solutions.

Cost per Verified View (CPV²). Cost per Verified View is the amount an advertiser pays for a consumer to view an advertisement that is verified.

Digital Ecosystem. The Digital Ecosystem pertains to all hardware, software, network (including but not limited to satellite, cable, telephone company, wireless, wireline networks), servers, communication systems, Internet, etc. that impact a Subscriber's digital advertising, video viewing, print media viewing, interaction, and account management experience.

Exchange Notes. An Exchange Note is a digital instrument or record held by a Service employing invention on behalf of a Subscriber that reflects a monetary value or credit earned by the Subscriber for viewing and engaging with an advertisement.

Exchange Value. The Exchange Value is a value calculated by the Exchange Value Engine (EVE) and is specific to an Advertising Viewing Event (AVE) that represents the degree of match between a Subscriber's profile and the Advertiser's Target Audience Profile that includes a monetary value an Advertiser will pay a Service Provider for the successful completion of a verified AVE. Advertisements may be presented by Exchange Value and ranked from highest to lowest.

Exchange Value Parameters. Exchange Value Parameters are factors and weights designated by the Advertiser that impact the Exchange Value assigned to an Advertising Viewing Event (AVE). Examples of Exchange Value Parameters include, but are not limited to: 1) Specifying a weight as to whether a Subscriber grants permissions to incorporate 3^{rd}-party demographic data in the calculation of an Exchange Value; 2) The results of incorporating 3^{rd}-party demographic data in the calculation of an Exchange Value; 3) Specifying a weight against the techniques for verifying that a specific Subscriber viewed a specific advertisement such as answering a question at the end of the ad, or answering multiple questions, and/or voice and/or facial recognition; 4) Specifying a weight to the degree of interactivity a Subscriber agrees to engage in; 5) Specifying a weight for allowing the collection of facial responses to watching advertisements; 6) Specifying a weight for access to Subscriber's Social Networks; 7) Specifying a Weight for access to mobile phone GPS systems and reporting; 8) Specifying a Maximum Exchange Value; 9) Weight for Subscriber granting permission for credit card verification, etc.

Facial Recognition. Subscriber is provided the option to enable facial recognition capability of the System Platform. Facial recognition is used to verify that the specific Subscriber completed an Advertisement Viewing Event (AVE). Verification that an advertisement is viewed is required before Exchange Notes can be issued for an AVE. It may also be used by the Advertiser, when permission is granted by the Subscriber, to measure the Subscriber's response while engaged in an AVE.

Live Video Content. Live Video Content is video content that is live and delivered to the Subscriber's viewing device(s) on a real-time basis. Examples of Live Video Content are news programming and sports events.

Network. Network includes all data networks and communication systems that link computer and software systems together across wireline, wireless, private, Internet, fiber optics, copper, satellite, twisted pair, or other medium that transmits digital communication.

Off-Ramp. Off-Ramp refers to the options presented to a Subscriber after he or she views an advertisement. Off-Ramp actions are part of the viewer verification process and impacts the Exchange Value at the close of the AVE. Off-Ramp options may include but not be limited to a post viewing survey question(s), telescoping to other information or advertisements, comments, click to chat with the brand represented by the advertiser, a link-out to other websites for information and activity, email, call to conversion (purchase), request for information, engage or share information, special offers, digital coupons, etc.

Paywalls. Paywalls are methods that restrict access to content from non-subscribers. Paywalls typically allow a visitor to become a subscriber or to pay for access to content on a limited per view basis.

Permissible Data Elements. Permissible Data Elements are Subscriber Profile Information or data that, through explicit permission by the Subscriber, can be used by a Service provider to characterize a Subscriber to the Advertiser. Permissible Data Elements are used by the Exchange Value Engine to rate the degree of match between Subscriber Profiles and Advertiser Target Audience Profiles and assign an Exchange Value to an AVE. Permissible Data Elements may include, but are not limited to, 3^{rd}-party data imported by the Service Provider to enhance a Subscriber's Profile as is expressly permitted by the Subscriber to the Service Provider. Permissible Data Elements may also include data from Subscriber's social networks, such as FaceBook, where the Subscriber grants a Service Provider employing various embodiments of the present invention, permission to access such information.

Personally Identifiable Information. Personally Identifiable Information is information that can be used to uniquely identify, contact, or locate a single person.

Profile Information. Profile Information is information provided by the Subscriber or data about the Subscriber imported from 3^{rd} party entities when permitted by the Subscriber about the Subscriber. Profile Information may include but not be limited to Personally Identifiable Information, interests, hobbies, brand preferences, credit card information, etc. Subscriber Profile Information may be subject to verification systems and procedures. When combined with 3^{rd} party information and permissions granted by the Subscriber, Permissible Data Elements are created.

Service. The Service is enabled by various embodiments of the present invention. Some of the features and attributes are described herein. The system for delivery of advertisement multimedia content is a combination of computer hardware, software, network elements, servers, routers, switches, appliances, etc. that together in combination, operates as a unique platform (System Platform) that serves the advertising viewing needs of the Subscriber in exchange for Exchange Notes. The Service may also provide direct access to video, print media and other content. The System Platform enables a multitude of novel and intelligent service attributes to Subscribers, Advertisers, and Content Owners and Aggregators by giving control of the viewing experience to the Subscriber. As a result, Advertisers will experience a substantially more efficient method of delivering advertisements to target audiences than current methods. Content Owners and Aggregators will be enabled to greatly improve the quality of a consumer's experience viewing advertising-supported content by the elimination of advertising breaks and intrusions.

Social Networks. Social Networks are web sites where Subscriber's spend time communicating with friends and other people willing to share information and interests. Examples are FaceBook, Google+, LinkedIn, etc.

Split Tender. Split Tender is a combination of Exchange Notes and cash Payment Methods used as payment for a license to view or purchase digital content, or purchase other goods and services. The cash portion of a Split Tender payment is typically through a credit card transaction. The ratio of Exchange Notes and cash is designated by the Subscriber.

Static Video Content. Static Video Content is video content that is not real-time. Examples of Static Video Content are movies and TV shows that are pre-recorded for later viewing by an audience.

Subscriber. A Subscriber is a Consumer who establishes and maintains an account on the Service's website. A Subscriber may also be a customer to the subscription service of a cable TV company, telephone company, satellite company, or other distributor of video content (access network) who uses the System Platform described herein to operate in conjunction with the access network. The Subscriber may also engage in an AVE for the purpose of purchasing content other than video such as but not limited to print media or to earn airline miles or engage in other loyalty programs or purchase products and services.

Subscriber Permissions. Subscriber Permissions are explicit instructions contained in the Subscriber's Profile Data that grant the Service provider permission to use technologies, techniques, Subscriber-provided Profile Information, 3^{rd}-party sources of consumer information, etc. for the purpose of establishing an Exchange Value assigned to a specific Advertising Viewing Event (AVE). Subscriber Permissions create Permissible Data Elements.

Subscriber Profile Data. Subscriber Profile Data are data provided by the Subscriber about the Subscriber. Subscriber Profile Data is synonymous with Subscriber Profile Information. It also contains data imported from 3^{rd} parties by permission and permissions the Subscriber grants to Service providers to collect and use a Subscriber's Profile Information (Permissible Data Elements). Permissions would be, for example, granting that a Service Provider could use 3^{rd}-party data for the calculation of the Exchange Value for an AVE. Or, it could be permission for a Service provider to collect data on Subscriber's behaviors as measured by various technologies and techniques such as Facial Motion and Behavior Capture or web surfing activities, etc. Permissions are also granted to the Service provider to verify Subscriber identity and validate Profile Information.

System Platform. The System Platform is composed of elements of the Subscriber's Digital Ecosystem that includes all hardware and software to enable Subscribers to control their advertising and multimedia content viewing experience. The System Platform can operate either in servers and computers at a remote data center, a hosted Cloud-based service, or in the hardware and software elements located and connected to the Access Network, or in all of the above. The Exchange Value Engine operates on the System Platform. Software, for browser-based access to the Subscriber accounts via the Service Provider's website, is located on servers at the Service Provider Data Center or on hosted Cloud-based Service Providers. Based on permissions granted by the Subscriber to the Service Provider, some software may be downloaded onto Subscriber devices (i.e., “cookies” or “pixels”). These small software programs are used to enhance the Subscribers' web-browsing experience. Application-based software, for mobile devices such as smartphones and tablets, provides access to the Service Providers' website to allow viewing of multimedia content.

Target Audience Profile Tags (TAP-Tags). Target Audience Profile Tags (TAP-Tags) are a data set created by the Advertiser that characterizes an ideal target audience for a specific Advertisement. TAP-Tags in combination with Subscriber Profile Information and other inputs, weights, and data are used by the Exchange Value Engine to match and rate the degree of match between profiles and then calculate an Exchange Value for an AVE.

Voice Recognition. Subscriber is provided the option to implement voice recognition as a tool to communicate with the Service. It is used in conjunction with the Subscriber Graphical User Interface (GUI) to respond to queries by the System Platform employed by the Service. Voice recognition may also be used for the verification by the advertiser that the advertisement was viewed by the specific Subscriber tied to the Exchange Value.

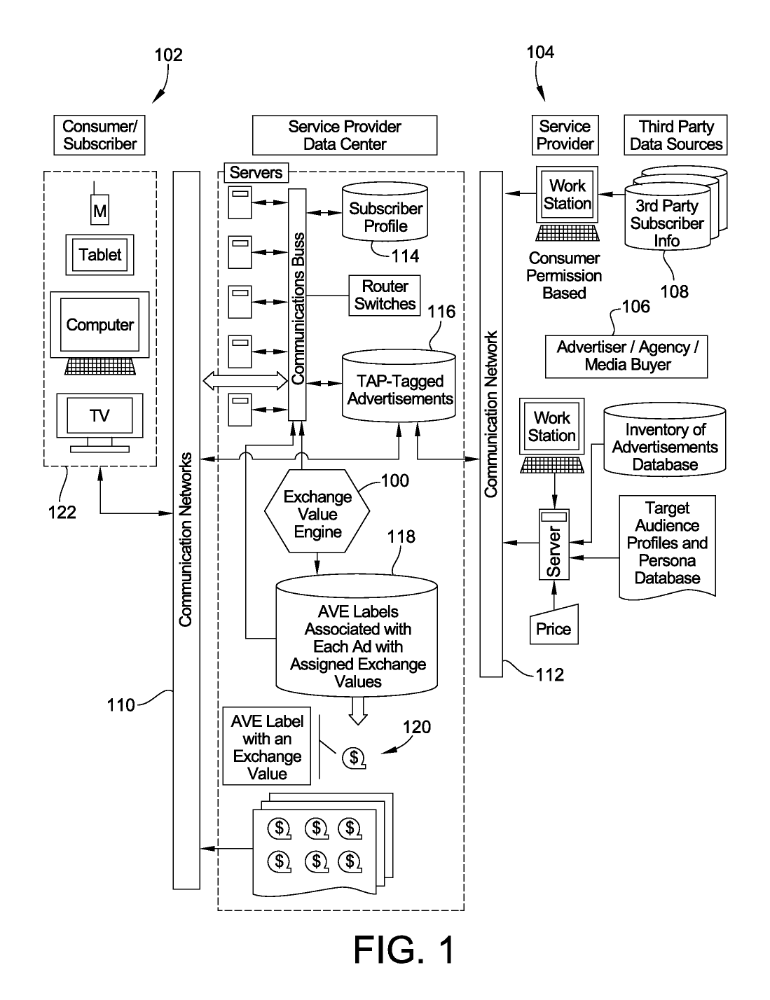

The schematic block diagram of FIG. 1 depicts a system for the delivery of advertising multimedia content (referred to oftentimes below as the “System Platform” or merely as “the system”) which illustrates how an Exchange Value Engine (EVE) 100, which is part of the System Platform, interacts with other systems to deliver relevant advertising content to Subscriber 102, in accordance with an embodiment of the invention. In particular embodiments, the Exchange Value 120 is based on Subscriber 102 and Advertiser 106 inputs.

A Subscriber 102 to a service that incorporates the System Platform can first create a Subscriber Account. Access to the Service can be through a variety of devices that may have web-browsing capability including smart phones, tablets, PCs or other devices connected to the Internet Access or through GUIs associated with a service provider's set-top box, home media gateway or other device. Access to the Service could also be through a branded smart-phone or tablet application “App,” set-top box, game device, home media gateway, or other device that is connected to and part of an Access Network and subscription video service that incorporates the System into their devices.

After an account has been created by the Subscriber 102, they are provided three options: 1) View ad-supported video content with or without advertising breaks; 2) View Advertising content in exchange for Exchange Notes 126 to be applied to viewing ad-supported video or other content without advertising breaks, moving through Paywalls, or other purchases or exchanges; or 3) Manage their accounts where Subscribers 102 enter profile data including but not limited to demographic information, interests, permissions to import profile information, and permissions to verify information using external sources of information and services.

Subscribers 102 input Profile Information that may include demographic information, interests, and permissions granted to the Service provider to import, validate, verify and use Subscriber's Profile Information in course of using a Service to deliver relevant advertisements at the convenience and control of the Subscriber 102. Advertisers 106 input Target Audience Profile Tags (TAP-Tags) through an Advertiser portal that characterizes an ideal consumer of an advertisement. The EVE 100 matches a TAP-Tag with a Subscriber's profile, rates the degree of match and then assigns an Exchange Value to the AVE that is specific to the Subscriber. Subscribers also grant the Service provider access to 3^{rd} party information about the Subscriber such as demographic data tied to zip codes, club memberships, etc. Subscribers also grant permission for Service providers to verify Profile information through 3^{rd} parties. This may include but not be limited to the use of credit card verification methods. Subscribers may also grant permissions to collect and use behavioral data that is collected from measuring and categorizing web browsing and video viewing activities but only on a strictly permission basis. All data collected in this manner is stored securely and is strictly controlled by the Subscriber through the Service provider. Use of Subscriber Profile Information by the Service is strictly on a permission-based OPT-IN basis. Subscriber Profile Information that is permissible for use by the Service provider is referred to as Permissible Data Elements.

The embodiment of FIG. 1 shows four system and technology groups. These groups include, but are not limited to, Subscriber 102 and their Consumer Devices 122, Service Provider 104 and the Service Provider Data Center that includes, but is not limited to, servers, computers, routers, switches and software including those for the Exchange Value Engine (EVE) 100, Advertiser 106 and their computers, servers, communication hubs, digital advertisements and databases, and External Databases 108 that contain 3^{rd} party Subscriber Data. Embodiments of the invention include the servers and computers in the Service Provider's Data Center(s) on which the EVE software operates. All four systems and technology groups are linked via data networks 110, 112. Consumers can communicate via internet protocol over local service provider broadband networks to access points on the internet to connect and communicate with the Service Provider Data Center and the EVE 100. Advertisers can communicate via over the internet or through a private data connection to the Service Provider Data Center.

In particular embodiments of the invention, the Data Center houses secure data files that are used in the operation and function of the EVE 100. These data files include, but are not limited to: 1) Subscriber Profiles 114; and 2) Advertiser-created Target Audience Profiles 124 tagged to an advertisement including price 125 and are inputs into the EVE 100 for the calculation and display of an Exchange Value to both the Subscriber 102 and the Advertiser 106. In certain embodiments, the output from the EVE 100 consists of small data files that are labels 118 describing an Advertising Viewing Event (AVE) associated with each advertisement. An Advertisement Viewing Event (AVE) is when a subscriber 102 selects, watches, interacts and verifies that they watched an advertisement. Each AVE label 118 includes a pictorial representation of the ad, description information and an Exchange Value 120.

The Exchange Value is a result of a dynamic set of calculations that take into consideration the degree of match between a Subscriber's Profile and the Advertisers Target Audience Profile (TAP) 124 for a particular advertisement combined with the Maximum Exchange Value assigned by the advertiser at the time an ad is TAP-Tagged and/or the use of Real-Time Dynamic Setting of Maximum Exchange Values by the System Platform. The EVE 100 may take into consideration: 1) Data provided by a specific Subscriber (Subscriber Profile Information); 2) 3^{rd}-party data about the Subscriber permitted by the Subscriber (for example, zip code information); 3) The degree a Subscriber 102 is willing to interact with an advertisement; 4) Permissions granted to the Service provider regarding access to the Subscriber's Profile Information and 3^{rd} Party Information (together referred to as Permissible Data Elements); 5) Permission to use credit card verification to validate identity; and 6) Advertiser Target Audience Profile Tags, weights, and Maximum Exchange Value parameters for CPV². The Exchange Value 120 varies across Subscribers 102 for a specific advertisement. It also varies over time with a specific Advertisement viewed by a Subscriber 102. The assignment of an Exchange Value 120 to a specific Advertising Viewing Event (AVE) is authorized by the Advertiser 106 and is affected by the Exchange Value Parameters designated by the Advertiser 106 through the TAP-Tagging process.

Permissible Data Elements (i.e., Subscriber Profile Information, permissions, and 3^{rd}-party data, etc.) may impact the calculation of the Exchange Value 120 associated with a prospective AVE. For example, if a Subscriber 102 grants permission to a Service Provider 104 to use 3^{rd}-party data and Subscriber Profile Information, the Exchange Value 120 for a specific AVE would likely be considerably higher than if such data were not permitted. The same would apply if the Subscriber 102 granted a high degree of interactivity during an AVE by selecting one of several Off-Ramp options. In such as case, the Exchange Value 120 would likely be considerably higher than if only a low degree of interactivity were granted and engagement with the ad was minimal.

As the number and velocity (growth rate) of AVEs are measured, the Advertiser 106 can specify automatic adjustments in the Maximum Exchange Value to either: 1) Reduce the Maximum Exchange Value; or 2) Increase the Maximum Exchange Value. The System Platform enables Advertisers 106 to capitalize on viral views of an advertisement based on its entertainment or informational value by effectively, and in real-time, reducing the Advertiser's cost (CPV²). On the other hand, if an advertisement has few AVEs, the Maximum Exchange Value can dynamically, and in real-time, increase the Maximum Exchange Value to stimulate AVEs. Higher Exchange Values 120 improve the placement of advertisements on page views for selection as well as the compensation a Subscriber 102 will receive after an AVE.

When a Subscriber 102 chooses an ad to watch by pointing to and selecting the ad representation with a pointing device, the advertisement and interactive elements are streamed to the Subscriber 102 over the broadband network. Consumer devices 122 employed by a Subscriber 102 to view ads and interact with the website experience include, but are not limited to, televisions, computers (laptop and desktop), tablets, and/or mobile phones (i.e., smartphones with data service).

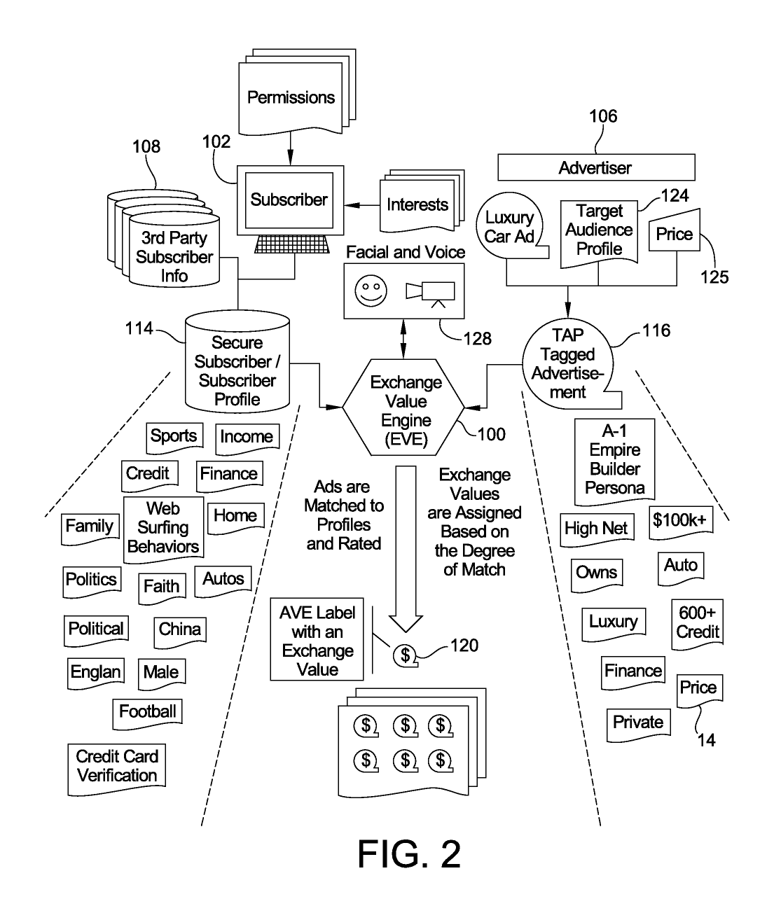

FIG. 2 is a schematic block diagram that shows how Exchange Values 120 are created and assigned to Advertising Viewing Events (AVEs), in accordance with an embodiment of the invention. AVE labels 118 are created by the EVE 100 and are unique to each Subscriber 102 for every ad that is in inventory at any moment in time. The EVE 100 matches Subscriber Profiles 114 with Advertiser Target Audience Profiles (TAPs) 124, rates the degree of match, and then assigns an Exchange Value 120 to the Advertisement Viewing Event (AVE) that is based on the Price 125 or Bid specified by the Advertiser 106 discounted by the degree of match. Subscriber Profiles 114 consist of data provided by a Subscriber 102. Such data consists of, but is not limited to, interests and permissions granted to the Service Provider 104 to import third-party demographic information 108 including but not limited to credit scores, the collection of behavioral data from browsers or other activity on the Subscriber's consumer devices 122, or the integration of commercially available Facial and Voice Recognition Hardware and Software 128.

Response recognition provides the Subscriber 102 a convenient means to provide anonymous feedback to the Advertiser in exchange for receiving higher Exchange Values for and AVE. Such quantification by the Service Provider 104 may be reported to an Advertiser 106 in the aggregate with other AVEs and characterized by profile attributes and not linked back to a specific Subscriber 102 who's Personally Identifiable Information is protected by the Service provider employing this invention. Facial recognition is executed in conjunction with a camera device pointing at the Subscriber 102 while they are viewing advertising content. If Subscriber 102 permissions are not granted, the system blocks the Service Provider 104 from collecting, using, and/or reporting subscriber facial motions associated with the specific AVE.

Facial Recognition Hardware and Software 128, whether combined or as separate devices, may be used to verify that an advertisement is viewed by a person who is represented by the Subscriber Profile 114 that is employed by the EVE 100 to establish the Exchange Value 120 for an Advertisement Viewing Event (AVE). A TAP-Tagged advertisement 116 contains information provided by Advertisers 106. Such information includes, but is not limited to, personas, credit score requirements, income requirements, interest profiles, demographic information, and other profiling information that describes the advertiser's Target Audience for the advertisement. The Exchange Value 120 assigned to the AVE Label 118 represents the value of a reward a Subscriber 102 receives after they view and engage an advertisement. The Exchange Value 120 also defines the cost an Advertiser 106 pays for a verified view.

The EVE 100 performs a multitude of functions that generate a variety of outputs. These outputs may include, but are not limited to: 1) Assigning the degree of match between the Subscriber Profile 114 and the Advertisers' Target Audience Profile 124 (TAP); 2) Assigning the Exchange Value 120 for an Advertisement Viewing Event (AVE); 3) Registering the number of verified views by Subscribers 102 within a Degree of Match category; 4) Measuring the number of Subscribers 102 who view an ad within the degree of Match Categories; 5) Calculating the Exchange Value 120 for an Advertisement Viewing Event (AVE) by adjusting the Price/Bid an Advertiser 106 assigns an ad when viewed by a Subscriber 102 with a perfect match to their Target Audience Profile 124; 6) Calculating and presenting the average cost per verified view; and 7) Calculating and presenting the average Exchange Value 120 reward to Subscribers 102 for viewing an ad.

Table 1, shown below, provides a set of exemplary outputs from the EVE 100 which are used in the calculation of Exchange Values 120 for a particular AVE where the sample population is one million subscribers. However, it should be noted that the EVE 100 does not choose ads for the Subscriber 102 to watch. All advertisements that have been placed on the Service Provider's website are available for viewing, even those that are a mismatch to a Subscriber's 102 demographics and interests. The EVE 100 matches the Subscriber's Profile 114 with the Advertisers' Target Audience Profile (TAP) 124 and rates the degree of match. After determining the degree of match, the Exchange Value Engine 100 calculates an Exchange Value 120 for the advertisement. That calculation takes into consideration the “price” or “bid” assigned to the advertisement by the Advertisers 106 for a perfect match to their Target Audience Profile 124 for that ad.

TABLE 1
Output from the EVE in the Calculation of Exchange Value for an AVE

| | | |
|---|---|---|
| Total Population of Subscribers: | 1,000,000 | |
| Price for a Perfect Match and a Verified View: | $0.570 | |
| Subscribers Viewing the Ad Flight (%): | 15% | {close oversize brace} |
| Subscribers Viewing the Ad Flight: | 150,000 | |

| | | | | | Adjusted | Exchange | Exchange |
|---|---|---|---|---|---|---|---|
| | | | | | Price/Bid | Value by | Value per |
| | | | Subscribers | Subscribers | Exchange | Degree of | Verified Ad |
| Degree of | Subscribers | | Viewing | Viewing | Value Set by | Match | View |
| Match | (%) | Subscribers | the Ad (%) | the Ad: | Advertiser | (Advertiser) | (Subscriber) |
| 100% | 0% | — | | | $0.570 | $0 | $0.428 |
| 95% | 1% | 10,000 | 25.0% | 37,500 | $0.542 | $20,325 | $0.407 |
| 90% | 2% | 20,000 | 30.0% | 45,000 | $0.513 | $23,085 | $0.385 |
| 85% | 3% | 30,000 | 15.0% | 22,500 | $0.485 | $10,913 | $0.364 |
| 80% | 5% | 50,000 | 10.0% | 15,000 | $0.456 | $6,840 | $0.342 |
| 75% | 6% | 60,000 | 8.0% | 12,000 | $0.428 | $5,136 | $0.321 |
| 70% | 8% | 80,000 | 5.0% | 7,500 | $0.399 | $2,993 | $0.299 |
| 65% | 10% | 100,000 | 4.0% | 6,000 | $0.371 | $2,226 | $0.278 |
| 60% | 14% | 140,000 | 1.2% | 1,800 | $0.342 | $616 | $0.257 |
| 55% | 20% | 200,000 | 0.7% | 1,050 | $0.314 | $330 | $0.236 |
| 50% | 15% | 150,000 | 0.4% | 600 | $0.285 | $171 | $0.214 |
| 45% | 10% | 100,000 | 0.2% | 300 | $0.257 | $77 | $0.193 |
| 40% | 3% | 30,000 | 0.2% | 300 | $0.228 | $68 | $0.171 |
| 35% | 2% | 20,000 | 0.2% | 300 | $0.199 | $60 | $0.149 |
| 30% | 1% | 10,000 | 0.1% | 150 | $0.171 | $26 | $0.128 |
| 25% | 0% | — | | — | $0.142 | $0 | $0.107 |
| 20% | 0% | — | | — | $0.114 | $0 | $0.086 |
| 15% | 0% | — | | — | $0.085 | $0 | $0.064 |
| 10% | 0% | — | | — | $0.057 | $0 | $0.043 |
| 5% | 0% | — | | — | $0.028 | $0 | $0.021 |
| 0% | 0% | — | | — | $0.000 | $0 | $0.000 |
| | 100% | 1,000,000 | | 150,000 | | $72,866 | |

| | |
|---|---|
| AVERAGE COST PER VERIFIED VIEW: | $0.486 |
| AVERAGE EXCHANGE VALUE REWARD TO SUBSCRIBER: | $0.364 |
| Based on Gross Margin of: | 25% |

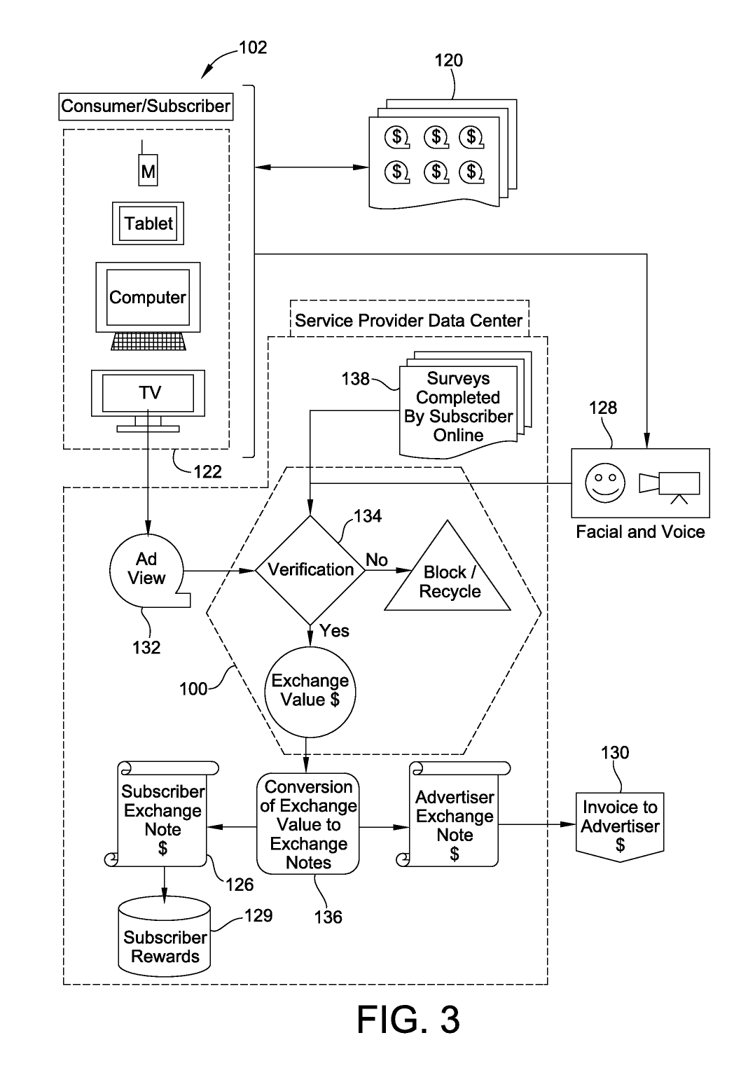

FIG. 3 is a schematic block diagram with a flowchart that illustrates a process for converting an Exchange Value 120 into an Exchange Note 126 or record after a verified view of an advertisement. Specifically, FIG. 3 illustrates the conversion of the Exchange Note 126 into a fungible Subscriber Reward 129 for Subscribers 102, and into a billing event 130 from the Service Provider 104 to the Advertiser 106. When Subscribers 102 select an ad to view 132, they are presented an Exchange Value 120 associated with the ad. After viewing the ad, the EVE 100 confirms and verifies that the ad was viewed 134 by one of several means. Verification of an ad view 134 may be done, for example, using facial and/or voice recognition hardware and software 128, by completion of a survey 138 by the Subscriber 102 or selecting an Off-Ramp.

An Exchange Note 126 may or may not have any value outside the Service as dictated by the Service. An example of an outside service would be a video service, print media service, incentive program, loyalty program, coupon program, etc. where an Exchange Note 16 might be traded. Exchange Notes 126 represent an obligation on the part of the Service to pay its value on demand when the Subscriber 102 renders it as payment. For example, an Exchange Note may be used for a license to view ad-supported video content without ad breaks. Or, an Exchange Note 126 may be exchanged for outside services or products via the issuance of a branded gift card. The value can be tied to hard currency such as U.S. Dollars. Exchange Notes 126 also represent an obligation on the part of the Advertiser 106 to pay the Service an amount equal to its face value plus the Service Provider's margin, and directly reflects an Advertiser's Cost Per Verified View (CPV²). It also may be used by the Subscriber 102 to pay for a license to view non-ad-supported video content. An Exchange Note 126 is created at the completion of an AVE. The cash value represented on the Exchange Note 126 is the Exchange Value 120 with adjustments such as, confirmed interactivity by the Subscriber 102 or other Off-Ramp actions a Subscriber 102 may take after viewing an advertisement.

In a particular embodiment, the EVE 100 determines if the Subscriber 102 has granted permission to use facial and/or voice recognition hardware and software 128 to verify 134 that the Subscriber 102 has viewed an ad that was selected and presented. If the Subscriber 102 has granted permission, then commercially available facial and voice recognition hardware and software 128 will be activated to provide the EVE 100 confirmation that the Subscriber 102 viewed the advertisement. In particular embodiments, the EVE 100 will first activate the Subscriber's camera on their viewing device and then guide the Subscriber 102 through a series of steps so that EVE 100 will be able to recognize when the Subscriber 102 is viewing an advertisement. This feature is designed improve the Subscriber's overall advertising experience by removing the requirement to verify a view 134 through other means such as completing a short survey 138.

An optional Voice Recognition/GUI interface enhances the Subscriber's experience with the Service by enabling hands-free commands and responses to System Platform queries pertaining to executing control over the Subscriber's viewing experience. When permitted, Voice Recognition also provides the Service Provider 104 a convenient method for a Subscriber 102 to confirm that they viewed a specific advertisement. Such a confirmation method could positively impact the calculation of Exchange Value 120 in the EVE 100.

When permitted by the Subscriber 102, the Facial Recognition program also allows the Service Provider 104 to analyze a Subscriber's response to a specific advertisement without requiring the Subscriber 102 to explicitly interact with the advertisement. Such information, in the aggregate, will allow the Service Provider 104 to provide valuable information back to the Advertiser 106 without revealing the Personally Identifiable Information of the Subscriber 102. Permissions granted by the Subscriber 102 for the use of facial and/or voice recognition impacts the calculation of an Exchange Value by the EVE that is specific to a Subscriber's participation in a specific AVE within a specific timeframe. As a Subscriber 102 provides a greater number and depth of profile information and permissions to a Service Provider 104, the EVE 100 will likely calculate a higher Exchange Value 120. Higher Exchange Values 120 are based on Advertiser's 106 prescribed parameters, weights and Maximum Exchange Value expressed in the Advertiser's Target Audience Profile 124 that is tagged to an AVE.

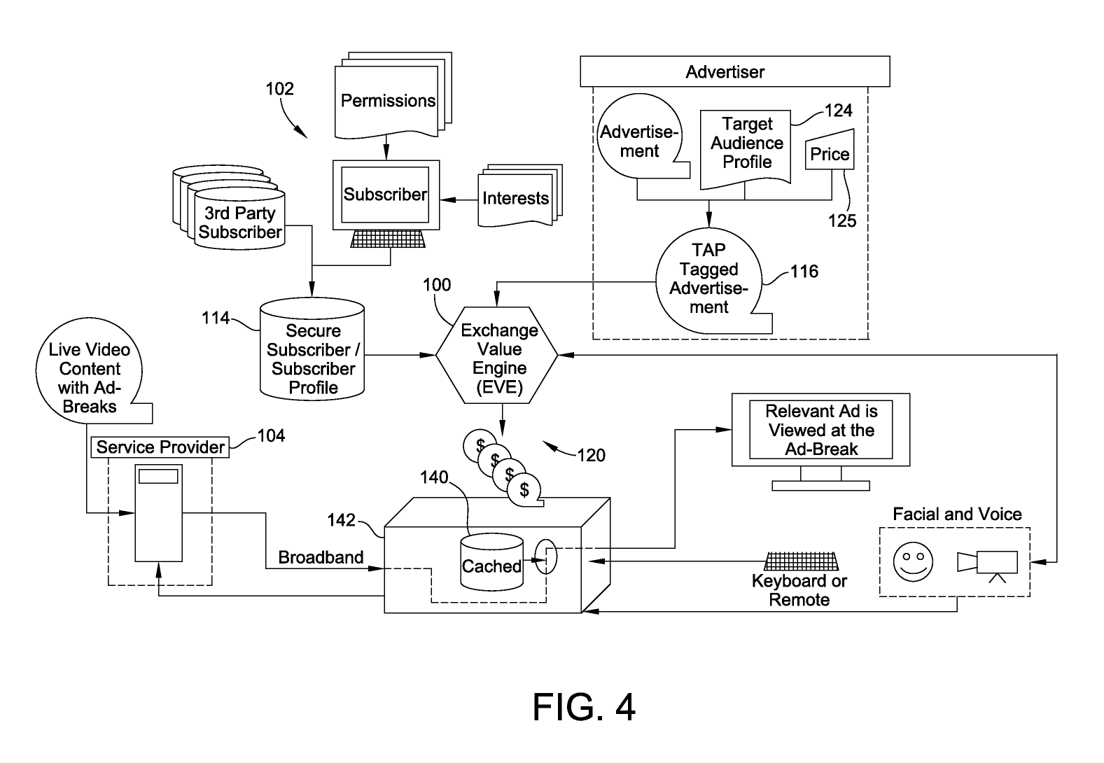

FIG. 4 is a schematic block diagram that illustrates how the EVE 100 enables the insertion of relevant advertisements in live ad-supported video content. Input into the Exchange Value Engine 100 comes from Subscribers 102 and Advertisers 106 including TAP-Tagged advertisements 116. The EVE 100 assigns an Exchange Value 120 to the TAP-Tagged advertisements 116, and then transmits, via a broadband link, advertisements with the highest Exchange Values 120 to a caching device 140 located within the Service Provider's set-top box or home media gateway 142. The cached ads that are stored and sorted by Exchange Value 120 and categorized according to ad length. When an ad break occurs in the live ad-supported content being distributed by a Service Provider 104 that matches the length, the advertisement with the highest Exchange Value 120 is inserted into the video stream for viewing. Verification that an advertisement was viewed can be provided in a multitude of ways including, but not limited to, a pointing device that communicates with the set-top box, a keyboard or Subscriber-enabled facial and/or voice recognition hardware and software 128. Verification of the view 134 (shown in FIG. 3) is provided back to the Service Provider 104 for billing to the Advertiser 106.

In a particular embodiment, the system platform provides Subscribers 102 control over the relevancy of ads presented to them while also simultaneously giving Subscribers 102 control over how relevancy is determined. In one embodiment, relevancy is established by Subscribers 102 creating profiles of information, or Subscriber Profiles 114, which may include demographic information, buying interests, brand preferences, hobbies, and intellectual pursuits of the Subscriber 102. Control over relevancy is accomplished by granting permission to Service Providers 104 for the use of such information (i.e., Permissible Data Elements) to suggest advertisements that are relevant to the Subscriber's interests. This control, provided by the Service Provider 104 employing various embodiments of this invention, assures privacy and security of the Subscriber's Profile 114, personally identifiable information, and their viewing experience. Control over Subscriber Profiles 114 and permissions and their privacy, security and enforcement of permissions provided by the Service Provider 104.

Further, the System Platform is configured to allow a Subscriber 102 to manage and control the quality and security of their video and other forms of digital advertising and ad-supported video or other digital content viewing experience. In at least one embodiment, the Subscriber to creates, manages, and controls a profile of their buying interests, brand preferences, hobbies, intellectual interests, and demographic data. The Subscriber also manages and controls permissions to the Service Provider 104 for allowing access to Subscriber-provided profile and demographic data, and for allowing the application of credit scoring data to the calculation of Exchange Values. Further, these permissions control how the Service interacts with video and other media transcoding devices, including their use of 3^{rd} party sources of user identification, such as credit card information provided by the Subscriber. This determines how credit card information can be used to verify Subscriber's identity. Additional permissions available to the Subscribe controls Service Provider interaction with social networks, and the level of Subscriber interactivity with an AVE that is acceptable to the Subscriber 102. The output from Subscriber inputs into account settings drive the output from a multitude of outputs and Service attributes from the at least one embodiment. The outputs from Subscriber inputs also directly impacts the Exchange Value 120 assigned by the EVE 100 to each AVE.

Permissions granted to Service Providers 104 by Subscribers 102 greatly improve the value proposition (i.e., Exchange Value 120) between the Subscriber 102 and the Advertiser 106 at the time the ad is consumed (i.e., the Advertisement Viewing Event or AVE). In at least one embodiment, the system platform enables Subscribers 102 to select the device that they choose to view video content and the time-shifted advertisements. Further, the system platform may be configured to provide Subscribers 102 control over the degree of interactivity the Subscriber 102 is willing to engage in with respect to a prospective Advertisement Viewing Event. The degree of interactivity granted the Service Provider 104 by a Subscriber 102, among other factors, impacts how the EVE 100 calculates an Exchange Value 120 that is specific to an Advertisement Viewing Event (AVE).

As stated above, the calculation and assignment of the Exchange Value 120 is performed by the EVE 100. Other factors that may be incorporated in to the EVE process include actions by Service Providers 104 granted explicit permission by the Subscriber 102 to: 1) Incorporate 3^{rd} party demographic, credit card verification and other Subscriber-related data into the Subscriber Profile 114; 2) Require interactivity during the AVE; 3) Collect data on Subscriber behaviors while the Subscriber 102 views the advertisement; and 4) Measure browsing activity while surfing the Internet.

In a particular embodiment, the output from the EVE 100 is an Exchange Value 120 that may be expressed in U.S. dollars, credits, points or some other designated currency that is assigned to a prospective AVE. After an AVE occurs and is verified, the Exchange Value 120 is adjusted and used to create an Exchange Note 126. The Exchange Note 126 may then be used along with other Exchange Notes 126 by the Subscriber 102 as partial or full payment for a license to view video, print media or other content, and in particular, ad-supported video and print media content without advertising breaks or intrusions. Exchange Notes 126 may also be used to purchase products and services directly, or traded for airline miles, loyalty programs, coupons, or other forms of incentives and offers. As explained above, there are multiple methods for verifying that a Subscriber 102 with a Subscriber Profile 114 viewed a specific advertisement. One method of verification is for the Subscriber 102 to answer one or several questions after viewing an advertisement. Another method of confirmation is facial recognition. Voice recognition also provides a method to communicate with the Service such as interactions with social networks in order to communicate ratings of viewed advertisements. Off-ramps are another method of achieving verification.

In particular embodiments, Subscribers 102 are queried to provide information such as buying interests, demographic information, other interests, etc. that would be of interest to Advertisers. Permitted information and data is fed to the EVE 100. The degree and quality of Subscriber Profile Information impacts the relevancy of advertisements recommended for view by the Service and the Exchange Value 120 of a prospective AVE.

In an embodiment, the System Platform is configured to manage the interface between the Service and outside social networks and websites when the Subscriber grants permission. Further, the system may be designed to process digital content to the specification defined by the Content Owner and Aggregator to include Digital Rights Management (DRM) and associated technologies of Digital Watermarking and Device Fingerprinting of digital content.

The System Platform can manage inventory of video, print media and other content, search tags, and other relevant information associated with the content such as pricing as it pertains to various licensing attributes for Subscriber viewing.

An AVE is specific to a Subscriber with a specific Profile Information viewing a specific advertisement within a specific time frame. Data that is used for calculating the Exchange Value include but are not limited to the following: 1) The degree of match between the Subscriber's Profile 114 and the Advertiser's Target Audience Profile (TAP) 124 for a given advertisement; 2) The Advertiser's assignment of a Maximum Exchange Value; 3) Permission and use of 3^{rd}-party demographic or other consumer data by the Service Provider 104; 4) Permission for the Service provider to validate Subscriber 102 identity with a credit card; 5) The degree of Subscriber 102 interactivity with the advertisement; and 6) Permission and use of Subscriber-provided Profile Information (Permissible Data Elements). All data used for the calculation of the Exchange Value 120 in the EVE 100 is permission-based and granted by the Subscriber 102. This system allows the Subscriber 102, through a series of Off-Ramp options, to exit the advertisement in order to purchase an item or service that is being advertised or to engage in other ways as defined by the Advertiser 106. The System Platform will provide either a completion of the purchase through the Service, or direct the Subscriber 102 to the product or service website to execute a purchase.

The System Platform is configured to allow Advertisers 106 to make real-time modifications to Maximum Exchange Values assigned to an advertisement, based on the number and rate of views of the advertisement. For example, if an advertisement becomes very popular for its entertainment value and the advertisement is recommended by the viewer to other Subscribers 102, the Advertiser 106 may see a rapid growth in the number of views. In such a case, the Advertiser 106 may wish to lower the Maximum Exchange Value in order to substantially reduce their Cost per Verified View (CPV²). If an advertisement lags in the number of views, the Advertiser 106 may wish to raise the Maximum Exchange Value in order to stimulate the number of views.

Hardware and software components can be located remotely in a dedicated or shared data center that is accessible by either an Internet connection or a private secure data lines. The software components can also be hosted on a dedicated server or on a cloud service provider's platform due the encryption of all customer data and Personally Identifiable Information within the software components.

There are three primary sources of information about the Subscriber 102. These include but are not limited to: 1) Information provided by the Subscriber directly into their profile database; 2) Information collected by the Service on Subscriber's web and viewing activities and stored in the Subscriber's profile database; and 3) 3^{rd}-party information about the Subscriber obtained through a supplier of 3^{rd}-party information or credit card verification. Subscribers 102 maintain control over the use of Subscriber 102 information by Advertisers 106 by expressly granting permission for its use. Permissions granted by the Subscriber 102 directly impact the calculation of the Exchange Value 120.

The Subscriber 102 has control over the use of face and voice recognition technology by the Service and by Advertisers 106 for the purpose of verifying that the Subscriber 102 has completed an AVE. It also provides the Subscriber control over the use of face recognition technology by an Advertiser 106 or other person or entity to measure the Subscriber's level of engagement and reaction when viewing an advertisement. For example, the Subscriber 102 has the option to choose facial and/or voice recognition as a means to verify that the Subscriber 102 has completed an AVE. Further, the Subscriber 102 has control over the degree of interactivity associated with the viewing an advertisement by the Subscriber 102. The degree of interactivity committed to by the Subscriber 102 directly impacts the calculation of the Exchange Value 120. Additionally, the Subscriber 102 controls how social networks interface with the Subscriber 102. The degree of Social Network permissions directly impacts the calculation of the Exchange Value 120.

As stated above, after a Subscriber 102 creates an account and logs into the Service, the Subscriber 102 may be presented with a welcome screen showing three choices depending on the Service Provider's services: 1) Watch a video such as an ad-supported movie or TV show, etc.; 2) Watch an advertisement (participate in an AVE); or 3) Manage the account. The EVE 100 enables Subscribers 102 to search for advertising content using various search and query options. There are two primary categories of advertising content served to the Subscriber 102 by the EVE 100 portion of the Invention: 1) Video (including Flash animation); and 2) Print Media. The EVE 100 displays images of advertising content (AVE labels) along with the Exchange Value 120, and includes the price or prices associated with viewing options such as: 1) A license to view once; 2) A license to view multiple times within a defined time frame; or 3) A license to purchase.

If the Service Provider 104 provides video content for viewing, the Subscriber 102 can choose a video for viewing. The options of payment for the selected video content are displayed. An exemplary set of options includes: 1) Exchange Notes 126; 2) Cash (credit card); or 3) Split Tender. The system includes “Split Tender” as a payment method to drive users to create an account and deposit currency into their account. For example, a user can view a particular piece of content and pay for the viewing with Exchange Notes 126, or alternatively pay with Split Tender at a lower effective rate, thereby encouraging the user to place currency in their account. This can be utilized to generate revenue and provide users an incentive to create an account.

If the Subscriber has sufficient Exchange Notes 126 in their account to cover the cost of viewing content, they can use Exchange Notes 126 exclusively for payment. If the Subscriber does not have sufficient Exchange Notes 126 to cover the cost of viewing content, they can either pay with a Cash Payment Method or pay with a combination of Exchange Notes 126 or Cash (credit card). This would be a modified version of Split Tender, but the content owner would only receive payment from the Subscriber's Service Provider 104. The Subscriber 102 then views the content. At the end of the view, the Subscriber 102 is provided an opportunity to rate the content, the rating to be shared with the Subscriber's social network and other Subscribers 102 to the Service. When payment is complete, the Subscriber 102 then views the content.

If the Subscriber 102 does not find content they desire to watch without advertising breaks or intrusions, they can search for content that contains advertising breaks or banners. The results of a search are displayed to the Subscriber on their viewing device. If there is no payment required, the Subscriber 102 orders and then views video content. Following the viewing event, the Subscriber 102 is provided the opportunity to rate the content. If viewing content with ad-breaks requires payment, the price, available Exchange Notes 126, and cash options are presented. If the Subscriber 102 chooses to view the content, a method of payment is selected relevant to viewing options such as a license to view once, a license to view multiple times within a defined time frame, or a license to purchase.

In order for a Subscriber 102 to use Exchange Notes 126 to pay for the license to view content, a Subscriber 102 must have a sufficient quantity of Exchange Notes 126 to make a purchase. Exchange Notes 126 are created as a result of a Subscriber 102 viewing an Advertisement and participating in an Advertising Viewing Event (AVE). To create Exchange Notes 126, a Subscriber 102 selects one or more advertisements to view. When a Subscriber 102 chooses to watch advertisements, they are presented recommendations. Subscribers 102 can also search for particular advertisements based on a multitude of criteria using a variety of search tools available on the system.

Advertisements can be recommended by the EVE 100 as a result of profiles of buying interests by the Subscriber and/or profiles built automatically by web-search and other behaviors tracked by the Service based on Subscriber's explicit permission to do so. Interests that impact buying relevancy may also be hobbies or other intellectual or physical activity interests. Subscribers to the Service employing one or more embodiments of the invention can browse ads to view by interest category. Or, Advertisements may be presented ranked by Exchange Value 120 only with ads with the highest Exchange Values 120 appearing at the top of the viewing page in rank order and so on down to the Advertisements with the lowest Exchange Values 120 placed at the bottom of the last page. Rank order presentations outside of any category preference provides Advertisers 106 the opportunity to deliver new material, products, branding, and services to the marketplace that may ordinarily find it hard to find an audience. A high Exchange Value 120 would act as an incentive to bring Subscribers 102 to view their advertisement.

Advertisements may be found using a keyword search, or through recommendations from other Subscribers. A Subscriber 102 may associate with other Subscribers on the system. Advertisements can be rated, for example, in order of the highest ratings provided by the Subscribers to the service. Further, Advertisements may be found using multiple search criteria. For example, a Subscriber 102 might wish to see using a filter, advertisements that are rated by a score of five or higher and ranked by Exchange Value 120. Also, advertisements may be presented by the degree of interactivity required by the advertisement.

The level of security is at the discretion of the Advertiser 106. The Advertiser 106 interacts directly with the System Platform using an online secure Graphical User Interface (GUI) or portal. The EVE 100 dynamically rates the degree of match between a Subscriber's Profile Information and the Advertisers Target Audience Profile 124 and assigns an Exchange Value 120 to the (AVE). The Exchange Value 120 is directly and algorithmically proportional to the degree of match between a Subscriber's Profile Information and the Advertiser's Target Audience Profile Tag for the AVE. Advertisers may specify and build Subscriber 102 interactivity into the AVE in the form of Off-Ramps for the Subscriber 102 to verify their view and to engage the Advertiser 106 directly. Off-Ramp options for Advertisers 106 include Post-View Survey, Telescoping, Comments, click-to-chat, link-out, email, call-to-conversion (sale), request information, engage/share, special offers, digital coupons, etc. Subscriber-controlled 3^{rd}-party data may be used in the calculation of an Exchange Value 120 for an AVE. The result is a specific advertisement that makes up an AVE with an assigned Exchange Value 120 with specified interactivity that the Subscriber 102 can choose to view. However, it should also be noted that the System Platform is also configured to deliver, to the Advertiser 106, anonymized Subscriber Profile Information that was used by the EVE 100 in the calculation of an Exchange Value 120 following completion of an AVE.

Upon completion of the AVE, the system determines and accounts for actions and transactions initiated by the Subscriber during the AVE. At least one embodiment then reconciles these actions and transactions with the assigned Exchange Values that were set prior to viewing the advertisement. Then at least one embodiment converts the Exchange Value associated with the advertisement to an Exchange Note to be applied to the Subscriber's account subject to adjustments. A 3^{rd}-parry verifies that a Profile 124 reflects an actual Subscriber 102 that participated in the AVE. Actions taken by the Subscriber during and after the advertisement would add or subtract Exchange Value during the conversion to an Exchange Note. For example, an action that would create a positive adjustment to the conversion of the Exchange Value 120 to the Exchange Note 126 would be the click-through purchase of products or services portrayed in the advertisement. Conversely, if the Subscriber 102 fails to interact with the advertisement as required, but is a verified view, a negative adjustment would occur to the conversion of the Exchange Value to the Exchange Notes 126. At least one embodiment then converts the reconciled Exchange Note 126 to a Cost per Verified View (CPV²), a monetary value that is accounted for and invoiced to the Advertiser 106 subject to 3^{rd} party verification.

In an embodiment of the invention, the Subscriber 102 can choose to manage their account and Service attributes. Subscriber Profile Information, Permissible Data Elements, and settings made by the Subscriber 102 directly control the Service, security and privacy settings, and the Exchange Value 120 received by the Subscriber 102 when they view advertisements. Exemplary options and service attributes include the following:

Buying Interest Profile. The Buying Interest Profile is data directly provided by the Subscriber 102 and/or collected under the explicit and direct control of the Subscriber 102. When the Subscriber 102 grants permission, Buying Interest Profile data are used by the EVE 100 for the Service Provider 104 to recommend advertisements for the Subscriber 102 to view. Buyer Interest Profile Information is also used by the EVE 100 to calculate the Exchange Value 120 of the Subscriber's viewing of a specific advertisement.

Security and Security Settings. The Privacy and Security Settings are a combination of permissions granted by the Subscriber 102 to the Service Provider 104.

Permission for Access to Demographic and Other 3^{rd}-Party Data. The Subscriber 102 manages and controls permission for Service Providers 104 to incorporate demographic and other 3^{rd}-party data into the calculation of the Exchange Value 120 assigned to a prospective and AVE to be viewed by the specific Subscriber 102 within a defined time period. These permissions are a major contributor to the calculation of Exchange Value 120.

Permission to Access Credit Scores. Similar to permissions granted to Service Providers 104 to access demographic and other 3^{rd}-party data about the Subscriber 102, the Subscriber 102 manages and controls permission for the Service to specifically incorporate credit scores into the calculation of the Exchange Value 120.

Credit Card Information. Subscribers 102 enter their credit card information into the system for the purpose of paying for content either in full or as part of a Split Tender transaction or using Exchange Notes 126 on other sites to move through content paywalls. Credit card information is also used to verify Subscriber identity on a permission basis. Credit card information may also be used for payment when a point-of-sale is made while watching an advertisement.

Access to Social Networks. Subscribers 102 control how the service and the Subscriber's account interact with social networks.

Settings for Device Transcoding. Subscribers 102 are provided options to define devices they wish to receive video and advertising content. The quality of the viewing experience can also be managed with consideration to the limitations of the access and other network elements critical to the transmission of the streaming digital data.

In a particular embodiment of the invention, the EVE 100 calculates and presents an Exchange Value 120 that is assigned to a specific prospective AVE to be viewed by a specific Subscriber 102 with specific Profile Information within a defined period of time. An outcome of the Subscriber's search and selection process can yield a display of advertisements recommended for the Subscriber 102 to view. When an AVE is completed by the Subscriber 102, the Exchange Value 120 is converted to an Exchange Note 126 for the Subscriber 102 to apply at some future time to the purchase of a license to view ad-supported video, print media content, or other content without advertising breaks. Exchange Notes 126 may also be used to purchase services or products with affiliates or to trade for coupons, loyalty programs, airline miles, or other consumer incentive programs that the Subscriber 102 may choose.

The Exchange Value 120 can be calculated by the EVE 100. Calculations include a number of data inputs including Target Advertising Profile Tags from the Advertiser 106, which include Maximum Exchange Values for perfect matches and Profile Information from the Subscriber 102. Data inputs include but are not limited to Subscriber-provided Permissible Data Elements that may include: 1) Subscriber interests; 2) Behavioral data; 3) 3^{rd}-party demographic data about the Subscriber 102; 4) Credit scores; 5) Brand preferences; 6) profile information; 7) zip codes; 8) Credit Card verification, etc. All data inputs about the Subscriber 102, whether directly provided by the Subscriber 102 or through permissions granted by the Subscriber 102 for the Service Provider 104 to import data from 3^{rd} parties, are controlled by the Subscriber 102.

Subscriber data used in the calculation of the Exchange Value are measured against Advertiser created Target Audience Profile Tags for advertisements. These data actively and dynamically interact within the EVE 100. In a particular embodiment, the Exchange Value Engine 100 operates to deliver to the Subscriber 102 control of their advertising content viewing experience. The EVE 100 delivers a dynamic method of assigning an Exchange Value 120 using Advertiser Target Audience Profile Tags matched to a specific Subscriber's Profile 114 and view of an advertisement (AVE) within a defined timeframe. The Subscriber 102 provides instructions to the Service Provider 104 that control and grant permissions on how the Service Provider 104 may or may not incorporate 3^{rd}-party data into the Subscriber's Profile 114. The Subscriber 102 also provides instructions and permissions to the Service Provider 104 to gather behavioral information for their Subscriber Profile 114 through various techniques such as voice or facial recognition, web browsing, facial motions and expressions during ad viewing, degree of interaction agreed to by the Subscriber 102, etc.

In certain embodiments, Exchange Values 120 will change with the input of weighting factors and parameters from the Advertiser 106, such as the inclusion of a Subscriber's zip code in the Subscriber's Profile 114. For example, if a Subscriber 102 grants permission to the Service Provider 104 to use the Subscriber's zip code for the purpose of importing 3^{rd}-party data into a Subscriber's Permissible Data Elements, an Exchange Value 120 to a prospective AVE would be higher than if permission were not granted. Or, by having just a zip code available as a Permissible Data Element, a higher Exchange Value 120 might, for example, be assigned to an AVE for snowshoes if the Subscriber 102 had a Maine zip code rather than a zip code from Florida. If the Subscriber 102 does not grant permission for the Service Provider 104 to use the Subscriber's zip code in the calculation of the Exchange Value, the Exchange Value 120 assigned would decrease due to the fact that the EVE 100 would not have information to value the viewer's physical location (i.e., their relevancy to the Advertiser 106.

The EVE 100 matches Permissible Data Elements such as Zip Codes to the Advertiser's Target Audience Profile Tags and weights in the calculation of Exchange Value 120. The EVE 100 accommodates a multitude of additional factors and demographic information from the Advertiser 106 that go well beyond zip codes for the calculation of the Exchange Value 120. They may include such information as membership in clubs, graduation from educational institutions, certificates, educational degrees, etc. Other factors may include the degree of interactivity that a Subscriber 102 agrees to when selecting a prospective AVE to engage. The factors can also be weighed by the Advertiser 106 in the Target Audience Profile Tags and incorporated into the calculation of the Exchange Value 120. For example, when a Subscriber 102 accepts a high degree of interactivity with an AVE, such acceptance will typically increase the Exchange Value 120 presented to the Subscriber 102. Limiting interactivity by the Subscriber 102 would conversely decrease the Exchange Value 120. As before, the weighting of the Target Audience Profile Tag parameters operating within the EVE 100 are under the management and control of the Advertiser 106.

Live content is video content that is being viewed real-time such as news and sports events. The AVE Labels 118 and a portion of the inventory of relevant Advertisements may be stored in the Home Media Gateway, Set-top Box, Game Station or other device connected to a viewing device and to the Network. The inventory of relevant advertisements is created by drawing on Subscriber-controlled profile information (i.e., Permissible Data Elements), the inventory of advertisements provided by the Advertisers 106, and Advertiser Target Audience Profiles 124 tagged to the advertisements. When an advertising break occurs, relevant advertisements are inserted into the advertising spot. Advertisements for insertion are modified to enable verification of view by the Subscriber 102 either by short survey questions or facial and voice recognition.

The overall system enables Subscribers 102 to control and improve their advertising viewing experience associated with viewing ad-supported live video content. Advertisements are made available by Advertisers 106 to the Service Provider 104, and the most relevant ads are cached on the Subscriber's device or with the Service Provider 104 prior to viewing live video content and for future insertion and viewing during the advertising breaks while watching live video content. When an advertising break occurs while the Subscriber 102 is viewing live video content, a relevant advertisement with the highest Exchange Value 120 is inserted from the inventory of relevant cached advertisements. Based on the permissions granted by the Subscriber 102, verification that the advertisement was actually viewed can occur.

It is intended that various embodiments of the system are to be technology-neutral. Furthermore, it is intended that the overall system and methods described herein will work with all forms of advertising-supported content, including voice, data, music, video, gaming, software, applications from application service providers (ASPs), education, digital print and all other digital content that is static, dynamic, or streaming. The system will operate as a server based system providing browser or branded application access to content and/or as an application operating within the home media gateway, game station, and subscription-based video service set-top boxes.

All references, including publications, patent applications, and patents cited herein are hereby incorporated in their entireties by reference thereto to the same extent as if each reference were individually and specifically indicated to be incorporated by reference and were set forth in its entirety herein. Additionally, the following references are hereby incorporated in their entireties by reference thereto: U.S. Pat. No. 7,925,533; U.S. Pat. No. 7,590,601; U.S. Pat. No. 7,401,150; U.S. Pat. No. 7,328,187; U.S. Pat. No. 6,973,475; U.S. Pat. No. 6,957,195; U.S. Patent Publication 20100010915; U.S. Patent Publication 20080065487; U.S. Patent Publication 20070219924; U.S. Patent Publication 20070219923; U.S. Patent Publication 20070215690; U.S. Patent Publication 20070055721; U.S. Patent Publication 20020143567; U.S. Patent Publication 20110166945; U.S. Patent Publication 20100332304; U.S. Patent Publication 20100332301; U.S. Patent Publication 20110022477; U.S. Patent Publication 20040133909; U.S. Patent Publication 20090132416; U.S. Patent Publication 20090094134; U.S. Patent Publication 20050060229; U.S. Patent Publication 20090070206; U.S. Patent Publication 20090006303; U.S. Patent Publication 20090198542; U.S. Patent Publication 20110078013; U.S. Patent Publication 20100228591; U.S. Patent Publication 20100228592; U.S. Patent Publication 20100070381; U.S. Patent Publication 20100010915; U.S. Patent Publication 20100303447; and U.S. Patent Publication 20100313218.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for providing control over the delivery, consumption, and exchange of value with an advertiser upon the selection and viewing of an advertisement by one or more subscribers to a media service, the method comprising:
collecting personal information related to the one or more subscribers; and
assigning exchange values to an advertisement, each of the exchange values being uniquely determined for each of the one or more subscribers, the respective exchange values being based on calculations that take into account the personal information collected from the respective one or more subscribers.

2. The method of claim 1, further comprising verifying the completion of each advertising viewing event, in which one of the one or more subscribers views and interacts with one of the advertisements.

3. The method of claim 2, further comprising dynamically adjusting the exchange values associated with the advertisement based on a total number of advertising viewing events for the advertisement.

4. The method of claim 2, further comprising dynamically adjusting the exchange values associated with the advertisement based on the advertiser set parameters within the target audience profile which indicate at which time of day and which days of the week the one or more subscribers will be most likely to be interested in the advertisement.

5. The method of claim 2, further comprising converting one of the exchange values for the advertisement into an exchange note upon verifying that one of the one or more subscribers, to whom the exchange value was assigned, has viewed the advertisement, constituting a completed advertising viewing event, wherein the exchange note can be used by the one of the one or more subscribers as currency for a purchase of goods and services.

6. The method of claim 5, further comprising delivering, to an advertiser, anonymized subscriber profile information that was used by the exchange value engine in the calculation of the exchange value.

7. The method of claim 5, further comprising:
a service provider maintaining the subscriber's exchange notes; and
the service provider providing media content or other products or services when the subscriber's exchange notes, or some portion thereof, are redeemed by the subscriber.

8. The method of claim 1, wherein collecting personal information related to one or more subscribers is permission-based, and comprises collecting one of demographic information, behavioral information, brand preferences, hobbies, interests, group affiliations, and credit information related to the one or more subscribers.

9. The method of claim 8, wherein collecting personal information related to one or more subscribers comprises collecting personal information from third-party databases.

10. The method of claim 8, wherein collecting personal information related to one or more subscribers comprises collecting personal information from data relating to the behavioral patterns of the one or more subscribes based on the use of internet connection devices and applications.

11. The method of claim 1, wherein assigning exchange values to an advertisement comprises an advertiser providing the advertisement and assigning to the advertisement a maximum exchange value.

12. The method of claim 11, further comprising creating a target audience profile for each advertisement, wherein the advertiser creates the target audience profile to identify a subscriber the advertiser would like to reach and most likely to be interested in the advertisement, and wherein the target audience profile is used to assign the maximum exchange value.

13. The method of claim 12, wherein assigning exchange values to an advertisement comprises rating a degree of match between a particular subscriber and the target audience profile.

14. The method of claim 1, further comprising tagging each advertisement with a target audience profile, wherein the target audience profile identifies a target audience of the advertisement that is most likely to be interested in the advertisement.

15. The method of claim 1, wherein assigning exchange values to an advertisement comprises creating an advertising viewing event label representing the advertisement and its exchange value.

16. The method of claim 15, further comprising ranking and ordering placement of the advertising viewing event label on a webpage, or other viewing device or graphical user interface, where the one or more subscribers select advertisements to view.

17. The method of claim 1, further comprising caching advertisements to a set-top box, home media gateway, or other device for the purpose of inserting relevant advertisements into live streaming media at advertising breaks.

18. The method of claim 17, wherein the assigned exchange values determine which advertisements are cached to the set-top boxes, home media gateways, or other devices of the one or more subscribers.

19. The method of claim 1, wherein collecting personal information related to the one or more subscribers comprises collecting only that personal information permitted by each of the one or more subscribers.

20. An exchange value engine comprising:
a computer server programmed to provide, via a network, targeted advertisements to one or more subscribers to a media service, wherein, to provide such targeted advertisements, the server is further programmed to receive target audience profiles from advertisers, and to collect personal information over the network, the personal information related to the one or more subscribers;
wherein the computer server is programmed to calculate exchange values for each of the targeted advertisements, based on the target audience profiles, which identify the subscriber targeted and most likely to be interested in the advertisement, and based on the personal information related to the one or more subscribers, wherein the exchange values associated with a particular targeted advertisement are unique for each of the one or more subscribers.

21. The exchange value engine of claim 20, wherein the server is further programmed to rate a degree of match between the personal information for each of the one or more subscribers and the target audience profile for each of the targeted advertisements.

22. The exchange value engine of claim 22, wherein the server is programmed to collect only the personal information permitted by each of the one or more subscribers.

23. The exchange value engine of claim 22, wherein the degree of match can increase or decrease with each piece of personal information that a subscriber permits to be collected.

24. The exchange value engine of claim 20, wherein the server is further programmed to track completion of an advertising viewing event, in which it is verified that a particular targeted advertisement has been viewed by any of the one or more subscribers.

25. The exchange value engine of claim 24, wherein the server includes facial recognition hardware and software configured to determine an identity of one of the one or more subscribers who has viewed a particular targeted advertisement.

26. The exchange value engine of claim 24, wherein the server includes voice recognition hardware and software configured to determine an identity of one of the one or more subscribers who has viewed a particular advertisement.

27. The exchange value engine of claim 20, wherein the server is programmed to convert one of the exchange values into an exchange note, which is credited to one of the one or more subscribers who has viewed the targeted advertisement associated with the one of the exchange values.

28. The exchange value engine of claim 27, wherein the server is programmed to calculate a cost per verified view to be invoiced to an advertiser.

29. The exchange value engine of claim 27, where the server is programmed deliver anonymized subscriber profile information employed by the exchange value engine for the calculation of the exchange value for an advertising viewing event to be provided advertisers along with invoicing for verified views of an advertisement.

30. The exchange value engine of claim 27, wherein the server is programmed to maintaining a subscriber's exchange note account, and further programmed to accept exchange notes as payment for the provision of media content, or other products and services.

31. The exchange value engine of claim 20, wherein the server is programmed to create an advertising viewing event label representing the targeted advertisement and its exchange value.

32. The exchange value engine of claim 31, wherein the server is further programmed to rank and order the advertising viewing event labels based on the exchange values used to create the advertising viewing event labels, and further programmed to place the ranked and ordered advertising viewing event labels on a webpage, or other viewing device or platform, where subscribers select advertisements to view.

33. The exchange value engine of claim 20, wherein the server is programmed to cache targeted advertisements with the highest exchange values to a set-top box, home media gateway, or other device for the purpose of inserting relevant targeted advertisements into live streaming media during advertising breaks.
